(19) United States
(12) Patent Application Publication
(10) Pub. No.: US 2012/0158661 A1
(43) Pub. Date: Jun. 21, 2012

(54) CONTEXT-SPECIFIC ROLLBACK

(75) Inventors: Desmond T. Lee, Redmond, WA (US); Vinit Ogale, Bellevue, WA (US); Keshava Prasad Subramanya, Bellevue, WA (US); Sri Sai Kameswara Pavan Kumar Kasturi, Redmond, WA (US); Hongliu Zheng, Sammamish, WA (US); Yunan Yuan, Redmond, WA (US); Gregory W. Nichols, Bellevue, WA (US); Stephan Doll, Seattle, WA (US); Kiran Kumar Dowluru, Redmond, WA (US); Wing Yu Christine Fok, Bellevue, WA (US)

(73) Assignee: Microsoft Corporation, Redmond, WA (US)

(21) Appl. No.: 12/969,255

(22) Filed: Dec. 15, 2010

(51) Int. Cl. G06F 17/00

(52) U.S. Cl. 707/649; 707/E17.007

(57) ABSTRACT

Some embodiments of the invention provide components and/or techniques that may assist in choosing a snapshot to which to roll back to address a system malfunction. For example, some embodiments of the invention may record various metrics describing the system's performance, reliability and/or functionality at the points at which various snapshots are taken, along any of numerous dimensions. When a user later indicates a desire to restore the system to a previous point, these metrics may be analyzed to choose a snapshot to which to roll back.

### FIELD OF THE INVENTION

This invention relates to computer software, and more particularly to restoring the state of software on a computer to a previous state.

### BACKGROUND

Some operating systems provide users the capability to “roll back” the operating system and/or applications executing on a computer to a state in which those components existed at a specific previous point in time (this capability is referred to herein as “system restore” capability, although any similarity between this term and capabilities provided by any one conventional operating system should not be read to limit the term to a set of functionality provided by that operating system). For example, system restore capability may allow a user to roll back system files, registry keys, installed applications, and/or other components to a state in which the components existed prior to a system malfunction or failure.

To enable system restore functionality, some operating systems take, on a periodic basis, a “snapshot” of some or all of the data residing on a computer's hard drive (e.g., a volume employed by an operating system on the hard drive) to create a checkpoint for the system as of the time the snapshot was taken. Some operating systems may also, or alternatively, take snapshots of some or all of the data residing on a computer's hard drive upon the occurrence of certain events, such as the installation of a new driver or application, or when a user requests that a snapshot be taken. The user may later roll back to a particular snapshot to restore the system to the state in which it existed as of the time the snapshot was taken. Usually, rolling back to a particular snapshot does not erase any user data that was created after the snapshot was taken (e.g., new documents, changes to spreadsheets, photos downloaded from a camera, etc.) but rather applies certain system settings to the operating system and/or applications that were in effect at the time the snapshot was taken.

Typically, users employ system restore functionality after a problem with the operating system and/or one or more applications becomes evident. For example, a user who notices that her computer has begun to run slowly over the last two days may attempt to roll back the system to its state as of five days ago, if she is confident that the system was functioning properly then.

### SUMMARY

Applicant has appreciated that users who employ system restore functionality often do not know how far to roll back the system to address a system problem. This may be for any of several reasons. For example, the user may not know when the system was last functioning properly. As an example, a user may notice a number of problems over an extended period, and may have no idea when the first of those problems first started occurring. As a result, users often choose a snapshot to which to roll back using techniques that are decidedly unscientific. For example, many users simply guess which snapshot is best. Others may decide to “play it safe” and roll back to the most recent snapshot taken. In this respect, some operating systems may urge users to roll back to the most recent snapshot because any applications installed after a snapshot may be lost, so rolling back to the most recent snapshot may be the least impactful option. However, rolling back to the most recent snapshot may not address the problem, and the ineffectiveness of doing this may not be immediately apparent to the user. Other users may simply guess when the system was last functioning properly and roll back to that point, which may address the problem but also unnecessarily cause system components to be removed.

Some embodiments of the invention provide techniques for choosing a snapshot to which to roll back. In some embodiments, various metrics relating to system performance are recorded when each snapshot is taken, and used to choose a snapshot to which to roll back upon the occurrence of a system malfunction. For example, a “snapshot chooser” component may process the metrics to choose a snapshot, or to assist the user with choosing a snapshot, based on any of numerous types of analysis, which may or may not depend on the type of system malfunction presently occurring. As a result, embodiments of the invention may assist with addressing any system problems, while avoiding collateral damage in the form of applications and/or data lost.

The foregoing is a non-limiting summary of the invention, which is defined by the attached claims.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a block diagram depicting example techniques and components for collecting system metrics data, which may be employed in choosing a system snapshot to which to roll back, in accordance with some embodiments of the invention;

FIG. 2 is a flowchart depicting an example technique for choosing a particular snapshot to which to roll back, in accordance with some embodiments of the invention;

FIG. 3 is an example computer which may be employed to implement some embodiments of the invention; and

FIG. 4 is a block diagram depicting an example memory on which instructions embodying aspects of the invention may be recorded.

### DETAILED DESCRIPTION

Some embodiments of the invention provide components and/or techniques which may assist in choosing a snapshot to which to roll back to address a system malfunction. For example, some embodiments of the invention collect various metrics describing the system's performance at the point at which snapshots are taken, along any of numerous dimensions. For example, a service (which may, for example, form part of an operating system, or be implemented in any of numerous other ways) may collect system “health information” proximate to (e.g., at) the time each snapshot is taken, describing how the system is performing at or around that time. When a user later indicates a desire to restore the system to a previous point, these metrics may be analyzed to choose a snapshot to which to roll back.

System metrics may be analyzed in any of numerous ways. In one example, system metrics may be examined in relation to a problem currently occurring. For example, if system metrics indicate that a system was performing well prior to a new driver being installed but then poorly thereafter, embodiments of the invention may recommend restoring the system to the state in which it existed prior to installation of the new driver. In another example, system metrics may be examined to determine the frequency with which certain errors occur. For example, if a particular application starts to malfunction hourly beginning on a certain day, then embodiments of the invention may recommend restoring the system to the state in which it existed prior to the start of these malfunctions. In another example, system metrics may be examined to determine when certain operations were last performed successfully (e.g., when a printer device was last used successfully, when a user last successfully connected to a particular Wi-fi hotspot, etc.) For example, if the user is trying to address a problem relating to printing or wireless connectivity, the system metrics may establish when these activities were last successfully performed, perhaps indicating that restoring the system to the state in which it existed at that point may address the problem. Any of numerous types of analysis may be performed, as system metrics may describe a system along any of numerous dimensions. By analyzing the metrics, embodiments of the invention may assist with identifying and/or approximating a point in time to which to roll back, so that the user need not guess and perhaps unnecessarily lose any applications and/or data (e.g., if the user selected a snapshot taken too far back in time) or not address the cause of a system malfunction (e.g., if the user selected a snapshot taken after a problem occurred).

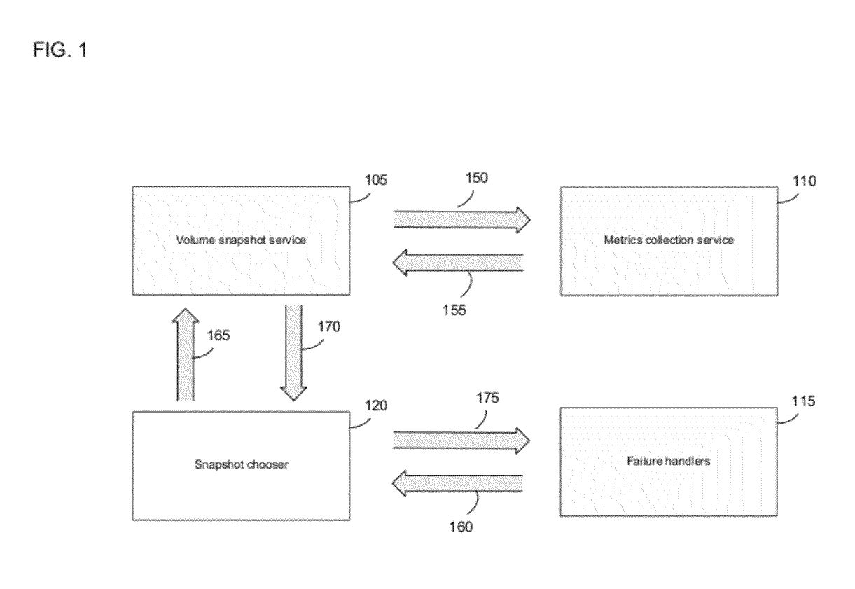

FIG. 1 depicts example components for collecting, storing and employing system metrics to identify a snapshot to which to roll back. Specifically, FIG. 1 depicts snapshot service 105, metric collection service 110, snapshot chooser 120 and failure handlers 115, each of which may form part of an operating system of a computer, be implemented as a standalone component, or be implemented in any other suitable fashion. Embodiments of the invention are not limited in this respect. In the example shown, when snapshot service 105 determines that a snapshot is to be taken (e.g., because a predetermined amount of time has passed since a last snapshot was taken, because a predetermined event has occurred, and/or at any other suitable time), snapshot service 105 issues a request to metrics collection service 110 to collect various system metrics, as indicated at 150. Of course, embodiments of the invention are not limited to collecting system metrics when a snapshot is to be taken. System metrics may be collected at any suitable interval(s) and/or upon any suitable event(s) occurring, which may or may not coincide with the interval(s) and/or event(s) upon which snapshots are taken. Embodiments of the invention are not limited to any particular implementation. Further, system metrics that are collected at different intervals than snapshots are taken may be associated with those snapshots using any suitable technique. For example, some embodiments may associate the system metrics collected the closest in time to a particular snapshot, others may associate those system metrics collected most recently prior to a snapshot being taken, and yet others may use other criteria for identifying system metrics collected proximate to a time at which a snapshot is taken. Embodiments of the invention are not limited to any particular implementation.

System metrics may characterize the system along any of numerous dimensions. For example, collected metrics may relate to system performance (e.g., they may include a sliding average of startup time over a particular time period, a sliding average of shutdown time over a particular time period, a sliding average of the launch time of individual applications over a particular time period, and/or any other suitable system performance measurement(s)), system reliability (e.g., they may include a number of times each application on the system stopped working over a particular time period, the number of times each application ceased responding (“froze”) over a particular time period, the number of times the operating system stopped working over a particular time period, and/or any other suitable system reliability measurement(s)), and/or system functionality (e.g., whether a particular printing device has been successfully employed since the last snapshot, whether the system has successfully connected to a particular network or access point since the last snapshot, whether a particular application has successfully launched since the last snapshot, whether an external device was successfully connected (measured by successfully loading a driver for the device) since the last snapshot, and/or any other suitable system functionality measurement(s)). Any of numerous system metrics may be captured, characterizing a system along any suitable dimension(s), as embodiments of the invention are not limited in this respect.

In the example depicted in FIG. 1, any system metrics collected by metrics collection service 110 are provided to snapshot service 105, as indicated at 155, and stored by snapshot service 105 in association with (e.g., with a notation referring to) a snapshot stored by snapshot 105, so that a set of metrics provides a record of the state of the system proximate to the time the snapshot was taken. Of course, embodiments of the invention are not limited to an implementation wherein snapshot service 105 stores system metrics collected by metrics collection service 110. For example, metrics collection service 110 may store collected metrics in a manner which allows access by snapshot service 105 when analysis is to be performed. Embodiments of the invention may store collected system metrics in any of numerous ways.

When a problem later occurs, failure handlers 115 provide failure information to snapshot chooser 120, as indicated at 160. This information may include, for example, data collected by the system and/or provided by a user relating to the failure. Any of numerous types of failure information may be provided.

Snapshot chooser 120 then queries system metrics data stored by snapshot service 105, as indicated at 165. For example, snapshot chooser 120 may query the system metrics data collected for various snapshots. Snapshot chooser 120 may then receive the results of the queries, as indicated at 170, and analyze those results. As noted above, any of numerous types of analysis may be performed, such as analysis relating to a particular type of malfunction described by the failure information provided at 160. As one example used to illustrate, if a user is unable to print using a particular printer device, then snapshot chooser 120 may query system metrics data to determine the last time that the printer device was used successfully.

Based on the results of the analysis, snapshot chooser 120 then generates a recommendation for a snapshot to which to roll back and provides the recommendation to failure handlers 115, as indicated at 175. This recommendation may be provided and/or expressed in any of numerous ways, as embodiments of the invention are not limited in this respect. For example, a recommendation may include an enumeration of available snapshots that may solve the problem, and/or identify a particular recommended snapshot. A recommendation may, for example, also include information which failure handlers 115 may use to generate guidance or instructions for the user, or if the user opts to have the system choose a snapshot to which to roll back, may cause failure handlers 115 to perform an automatic roll back to that snapshot. Any of numerous actions may be taken upon identifying a snapshot to which to roll back based on analysis of system metrics, as embodiments of the invention are not limited in this respect.

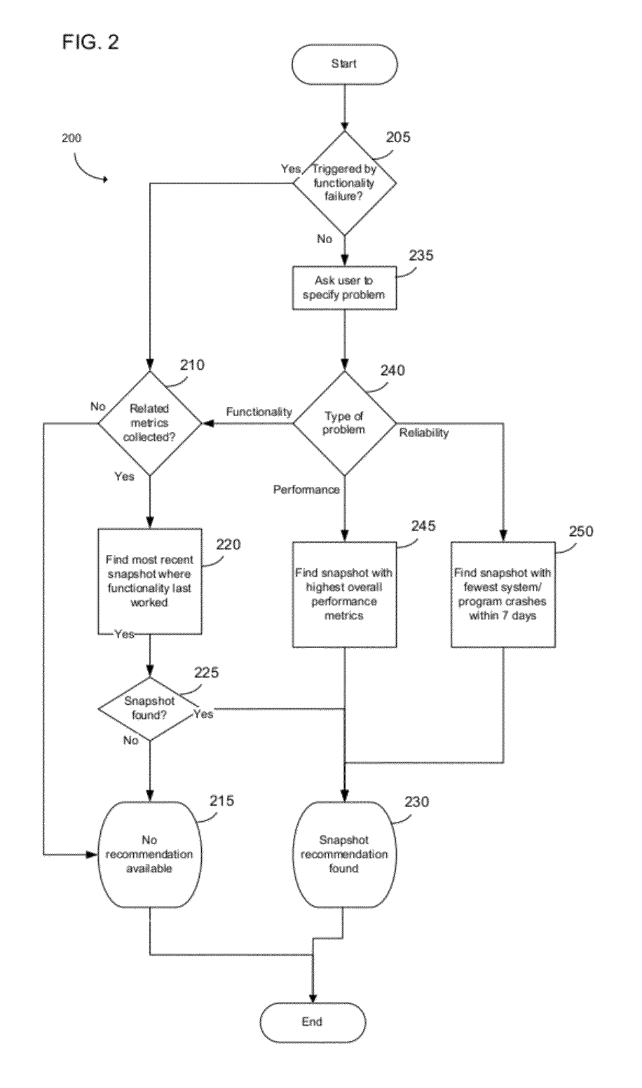

FIG. 2 depicts an example process which may be performed by snapshot chooser 120 (FIG. 1) to choose a snapshot to which to roll back. At the start of process 200, a determination is made in act 205 whether the need to restore the system is triggered by a functionality failure. This may be determined in any of numerous ways, such as based on information provided by failure handlers 115. If it is determined in act 205 the need to restore the system is triggered by a functionality failure, then process 200 proceeds to act 210, wherein it is determined whether metrics related to the functionality failure have been collected. If not, process 200 proceeds to act 215, wherein an indication is provided (e.g., to a user and/or system component) that no recommendation can be made. Process 200 then completes.

However, if it is determined in act 210 that related metrics were collected, then process 200 proceeds to act 220, wherein the most recent snapshot including an indication that the considered functionality last worked is identified. Process 200 then proceeds to act 225, wherein it is determined whether the snapshot is found. If so, process 200 proceeds to act 230, wherein an indication is provided (e.g., to a user and/or system component) of the recommended snapshot. If, however, it is determined in act 225 that no such snapshot can be found, then process 200 proceeds to act 215, wherein an indication is provided (e.g., to a user and/or system component) that no recommendation can be made. Upon the completion of either of acts 215 or 230, process 200 completes.

Returning to act 205, if it is determined that the need to restore the system is not triggered by a functionality failure, then process 200 proceeds to act 235, wherein the user is asked to specify the nature of the problem. For example, a dialogue box may be presented which prompts the user to indicate whether the problem relates to system functionality, performance of reliability. If it is determined in act 240 that the problem relates to functionality, then process 200 proceeds to act 210, wherein it is determined whether any related metrics have been collected, and process 200 continues as described above.

If it is determined in act 240 that the problem relates to performance, then process 200 proceeds to act 245, wherein a snapshot is located with the highest overall performance metrics. The identification of a snapshot having the highest overall performance metrics may be determined in any of numerous ways, as embodiments of the invention are not limited in this respect. For example, a snapshot having the lowest associated sliding average of startup time over a particular time period, sliding average of shutdown time over a particular time period, sliding average of launch time of individual applications over a particular time period, and/or best other indicator of system performance may be chosen. Embodiments of the invention are not limited in this respect. Process 200 then proceeds to act 230, wherein an indication is provided (e.g., to a user and/or system component) of the recommended snapshot (i.e., that which is identified in act 245). Process 200 then completes.

If it is determined in act 240 that the problem relates to reliability, then process 200 proceeds to act 250. In this example, the snapshot with the fewest system and/or application crashes within the last seven days is located. However, it should be appreciated that any suitable measure of system reliability may alternatively be considered, as embodiments of the invention are not limited in this respect. Process 200 then proceeds to act 230, wherein an indication is provided (e.g., to a user and/or system component) of the recommended snapshot (i.e., that which is identified in act 250). Process 200 then completes.

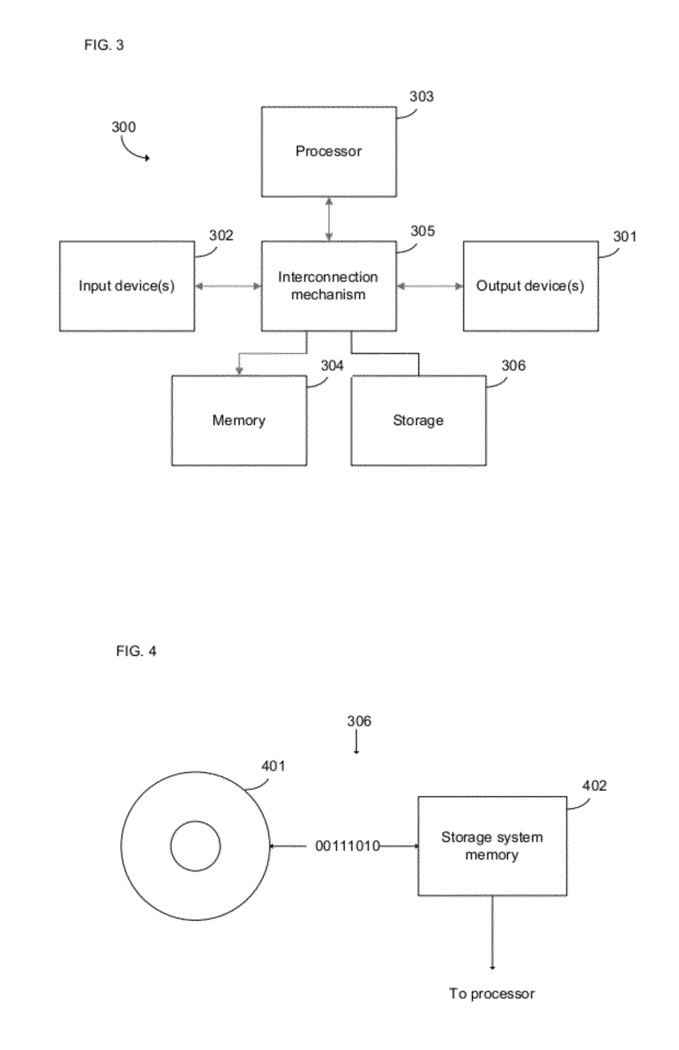

Various aspects of the systems and methods for practicing features of the present invention may be implemented on one or more computer systems, such as the exemplary computer system 300 shown in FIG. 3. Computer system 300 includes input device(s) 302, output device(s) 301, processor 303, memory system 304 and storage 306, all of which are coupled, directly or indirectly, via interconnection mechanism 305, which may comprise one or more buses, switches, networks and/or any other suitable interconnection. The input device(s) 302 receive(s) input from a user or machine (e.g., a human operator), and the output device(s) 301 display(s) or transmit(s) information to a user or machine (e.g., a liquid crystal display). The input and output device(s) can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

The processor 303 typically executes a computer program called an operating system (e.g., a Microsoft Windows-family operating system, or any other suitable operating system) which controls the execution of other computer programs, and provides scheduling, input/output and other device control, accounting, compilation, storage assignment, data management, memory management, communication and dataflow control. Collectively, the processor and operating system define the computer platform for which application programs and other computer program languages are written.

Processor 303 may also execute one or more computer programs to implement various functions. These computer programs may be written in any type of computer program language, including a procedural programming language, object-oriented programming language, macro language, or combination thereof. These computer programs may be stored in storage system 306. Storage system 306 may hold information on a volatile or non-volatile medium, and may be fixed or removable. Storage system 306 is shown in greater detail in FIG. 4.

Storage system 306 may include a tangible computer-readable and writable non-volatile recording medium 401, on which signals are stored that define a computer program or information to be used by the program. The recording medium may, for example, be disk memory, flash memory, and/or any other article(s) of manufacture usable to record and store information. Typically, in operation, the processor 303 causes data to be read from the nonvolatile recording medium 301 into a volatile memory 402 (e.g., a random access memory, or RAM) that allows for faster access to the information by the processor 303 than does the medium 401. The memory 402 may be located in the storage system 306 or in memory system 304, shown in FIG. 3. The processor 303 generally manipulates the data within the integrated circuit memory 304, 402 and then copies the data to the medium 401 after processing is completed. A variety of mechanisms are known for managing data movement between the medium 401 and the integrated circuit memory element 304, 402, and the invention is not limited to any mechanism, whether now known or later developed. The invention is also not limited to a particular memory system 304 or storage system 306.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers and/or systems. Such processors may be implemented as integrated circuits, with one or more processors in an integrated circuit component, though a processor may be implemented using circuitry in any suitable format.

It should be appreciated that any component or collection of components that perform the functions described herein can be generically considered as one or more controllers that control the above-discussed functions. The one or more controllers can be implemented in numerous ways, such as with dedicated hardware, or by employing one or more processors that are programmed using microcode or software to perform the functions recited above. Where a controller stores or provides data for system operation, such data may be stored in a central repository, in a plurality of repositories, or a combination thereof.

It should also be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound-generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual environment.

In this respect, the invention may be embodied as a computer-readable medium (or multiple computer-readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other non-transitory, tangible computer-readable storage medium) encoded with one or more programs that, when executed on one or more computers or other processors, perform methods that implement the various embodiments of the invention discussed above. The computer-readable medium or media can be transportable, such that the program or programs stored thereon can be loaded onto one or more different computers or other processors to implement various aspects of the present invention as discussed above. As used herein, the term “non-transitory computer-readable storage medium” encompasses only a computer-readable medium that can be considered to be a manufacture (i.e., article of manufacture) or a machine.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in the illustrative embodiments described herein.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items. What is claimed is:

1. A method for use in a system that provides a capability whereby a snapshot is taken periodically defining a state of the system as of a time the snapshot is taken, a plurality of snapshots are stored, and a user is allowed to choose a particular snapshot to restore the system to a state as of the time the particular snapshot was taken, the method comprising:
(A) accessing metrics characterizing system performance, reliability or functionality proximate to times at which at least some of the plurality of snapshots are taken;
(B) analyzing the metrics to identify a recommended snapshot to which to restore the system.

2. The method of claim 1, wherein the system comprises an operating system, and wherein (A) and (B) performed by components of the operating system.

3. The method of claim 1, wherein (B) is performed upon a system malfunction occurring.

4. The method of claim 1, wherein (B) comprises analyzing the metrics to determine a time at which a component was installed.

5. The method of claim 1, wherein (B) comprises analyzing the metrics to determine when a type of malfunction first began occurring.

6. The method of claim 1, wherein (B) comprises analyzing the metrics to determine when a type of system operation was last successfully performed.

7. The method of claim 1, further comprising:
(C) automatically restoring the system to the recommended snapshot automatically.

8. The method of claim 1, further comprising:
(C) presenting a recommendation to a user to restore the system to the recommended snapshot.

9. A computer-readable medium having instructions encoded therein which, when executed, perform a method for use in a system that provides a capability whereby a snapshot is taken periodically defining a state of the system at a time the snapshot is taken, a plurality of snapshots are stored, and a user is allowed to choose a particular snapshot to restore the system to a state as of the time the particular snapshot was taken, the method comprising:
(A) recording metrics characterizing system performance, reliability or functionality proximate to times at which at least some of the plurality of snapshots are taken;
(B) analyzing the metrics to identify a recommended snapshot to which to restore the system.

10. The method of claim 9, wherein (B) is performed upon a system malfunction occurring.

11. The method of claim 9, wherein (B) comprises analyzing the metrics to determine a time at which a component was installed.

12. The method of claim 9, wherein (B) comprises analyzing the metrics to determine when a type of malfunction first began occurring.

13. The method of claim 9, wherein (B) comprises analyzing the metrics to determine when a type of system operation was last successfully performed.

14. The method of claim 9, further comprising:
(C) automatically restoring the system to the recommended snapshot automatically.

15. The method of claim 9, further comprising:
(C) presenting a recommendation to a user to restore the system to the recommended snapshot.

16. A system, comprising:
at least one processor, programmed to:
take a snapshot defining a state of the system at a time the snapshot is taken; and
allow a user to choose a particular snapshot to restore the system to its state as of the time the particular snapshot was taken;
at least one storage medium, storing:
the plurality of snapshots; and
metrics characterizing system performance, reliability or functionality proximate to times at which at least some of the plurality of snapshots are taken;
wherein the at least one processor is further programmed to analyze the metrics to identify a recommended snapshot to which to restore the system.

17. The system of claim 16, wherein the at least one processor is programmed to analyze the metrics to identify a recommended snapshot to which to restore the system upon a system malfunction occurring.

18. The method of claim 16, wherein the at least one processor is programmed to analyze the metrics to determine a time at which a component was installed.

19. The method of claim 16, wherein the at least one processor is programmed to analyze the metrics to determine when a type of malfunction first began occurring.

20. The method of claim 16, the at least one processor is programmed to analyze the metrics to determine when a type of system operation was last successfully performed.
